(19) United States
(12) Patent Application Publication
(10) Pub. No.: US 2026/0268374 A1
(43) Pub. Date: Sep. 10, 2026

(54) INFORMATION PROCESSING APPARATUS, PRODUCT ADVERTISEMENT METHOD, AND NON-TRANSITORY COMPUTER-READABLE MEDIUM

(71) Applicant: NEC Corporation, Tokyo (JP)

(72) Inventor: Kouji HASEGAWA, Tokyo (JP)

(73) Assignee: NEC Corporation, Tokyo (JP)

(21) Appl. No.: 19/164,313

(22) PCT Filed: Mar. 23, 2023
(86) PCT No.: PCT/JP2023/011399

§ 371 Date: Sep. 11, 2025

(51) Int. Cl. G06Q 30/0241; G06Q 30/0601

(52) U.S. Cl. CPC G06Q 30/0276; G06Q 30/0643

(57) ABSTRACT

An information processing device is provided with an image acquisition unit, a reference information acquisition unit, an advertisement image generation unit, and a display output unit. The image acquisition unit acquires an image of a product to be advertised. The reference information acquisition unit acquires reference information to be used for determining additional data for the acquired image of the product. The advertisement image generation unit generates an advertisement image by using the image of the product and the additional data determined on the basis of the acquired reference information. The display output unit outputs the generated advertisement image to a display device associated with a store selling the product.

### TECHNICAL FIELD

The present invention relates to an information processing device, a product advertisement method, and a non-transitory computer-readable recording medium.

### BACKGROUND ART

Examples of techniques for displaying an advertisement of a product on a display device are disclosed in following PTLs 1 to 4.

PTL 1 discloses a display device that allows video content to be viewed and listened to inside and outside a store in a shared manner. The display device described in PTL 1 includes a first planar display constituted with a high-luminance light-emitting diode (LED) vision designed for outdoors and a second planar display constituted with an organic electro-luminescence (EL) display or a liquid crystal display designed for indoors.

PTL 2 discloses a technique for promoting sales of a product in consideration of demand fluctuations based on weather. For example, PTL 2 discloses that, in product sales promotion, information regarding a related article that contributes to sales promotion of a certain product is specified based on weather information, and content for sales promotion including information regarding the certain product and the related product is created and displayed.

PTL 3 discloses a technique for effectively promoting sales of a product, based on a behavior of a customer. For example, PTL 3 discloses a technique for verifying a degree of attention of a customer for a certain product, based on a behavior of the customer for the certain product in a store, and verifying whether to perform sales promotion for the certain product, based on the verified degree of attention.

PTL 4 discloses a technique for improving efficiency of publicizing a product to a target person. For example, PTL 4 discloses that the content of an advertisement (a product to be publicized) to be displayed on a display device is changed according to time.

### CITATION LIST

### Patent Literature

PTL 1: JP 2021-107908 A
PTL 2: JP 2021-051553 A
PTL 3: JP 2014-056356 A
PTL 4: JP 2013-164431 A

### SUMMARY OF INVENTION

### Technical Problem

In cited literatures 1 to 4 described above, there is a disadvantage that their techniques do not sufficiently devise ways to further enhance the appeal of a product targeted for advertising, and there remains room for enhancing the appeal effect of the product advertisement.

In view of the above-described problems, an example of an object of the present invention is to provide an information processing device, a product advertisement method, and a non-transitory computer-readable recording medium capable of enhancing an appeal effect of a product advertisement.

### Solution to Problem

According to one aspect of the present invention,
provided is an information processing device including
an image acquisition means for acquiring an image of a product targeted for advertising,
a reference information acquisition means for acquiring reference information to be used to determine additional data for the image,
an advertisement image generation means for generating an advertisement image, using the image and the additional data determined based on the reference information, and
a display output means for outputting the advertisement image to a display device associated with a store that sells the product.

According to one aspect of the present invention,
provided is a product advertisement method
performed by at least one computer and including
acquiring an image of a product targeted for advertising,
acquiring reference information to be used to determine additional data for the image,
generating an advertisement image, using the image and the additional data determined based on the reference information, and
outputting the advertisement image to a display device associated with a store that sells the product.

According to one aspect of the present invention,
provided is a non-transitory computer-readable recording medium recording a program
for causing, by being executed by at least one computer, the at least one computer to function as
an image acquisition means for acquiring an image of a product targeted for advertising,
a reference information acquisition means for acquiring reference information to be used to determine additional data for the image,
an advertisement image generation means for generating an advertisement image, using the image and the additional data determined based on the reference information, and
a display output means for outputting the advertisement image to a display device associated with a store that sells the product.

### Advantageous Effects of Invention

According to one aspect of the present invention, an information processing device, a product advertisement method, and a non-transitory computer-readable recording medium for enhancing an appeal effect of a product advertisement are provided.

### BRIEF DESCRIPTION OF DRAWINGS

FIG. 1 It is a diagram depicting an outline of an information processing device according to a first example embodiment.

FIG. 2 It is a diagram illustrating a hardware configuration of a computer that implements the information processing device according to the present disclosure.

FIG. 3 It is a flowchart illustrating a process executed by the information processing device according to the first example embodiment.

FIG. 4 It is a diagram illustratively depicting a configuration of a product advertisement system including the information processing device.

FIG. 5 It is a diagram for explaining an operation of an image acquisition unit according to a second example embodiment.

FIG. 6 It is a diagram for explaining an operation of a reference information acquisition unit according to the second example embodiment.

FIG. 7 It is a diagram for explaining an operation of an advertisement image generation unit according to the second example embodiment.

FIG. 8 It is a diagram depicting an example of an advertisement image generated by the advertisement image generation unit, based on information indicating a delivery status of a product.

FIG. 9 It is a diagram depicting an example of an advertisement image generated by the advertisement image generation unit, based on information indicating a delivery status of a product.

FIG. 10 It is a diagram depicting an example of an advertisement image generated by the advertisement image generation unit, based on information indicating an inventory status of a product.

FIG. 11 It is a diagram depicting an example of an advertisement image generated by the advertisement image generation unit, based on time information.

FIG. 12 It is a diagram depicting an example of an advertisement image generated by the advertisement image generation unit, based on climate information.

FIG. 13 It is a diagram depicting an example of information defining a correspondence relationship between delivery statuses indicated by delivery information and message data to be added to an image.

FIG. 14 It is a diagram depicting an example of an advertisement image generated by the advertisement image generation unit 130 according to a modification of the second example embodiment.

FIG. 15 It is a diagram depicting an example of information defining a correspondence relationship between types of reference information and priority ranks.

### EXAMPLE EMBODIMENT

Hereinafter, example embodiments of the present invention will be described with reference to the drawings. In all the drawings, the same components are denoted by the same reference signs, and the description thereof will be omitted as appropriate. Unless otherwise described, in each block diagram, each block represents not a configuration of a hardware unit but a configuration of a functional unit. In a case where elements such as blocks in the figure are linked by arrows, the directions of the arrows are merely intended to facilitate understanding of the flow of information. In this case, the direction of the arrow does not limit the direction of communication (one-way communication or two-way communication) unless otherwise described.

In the following description, “acquisition” includes at least one of fetching, by a host device, data or information stored in another device or a storage medium (active acquisition) and inputting, to the host device, data or information output from another device (passive acquisition). Examples of the active acquisition include requesting or inquiring another device and receiving a reply thereto, and accessing and reading another device or a storage medium. Examples of the passive acquisition include receiving information that has been distributed (alternatively, transmitted or issued as a push notification, for example). Furthermore, “acquisition” may mean selectively acquiring from among received data or information or selectively receiving distributed data or information.

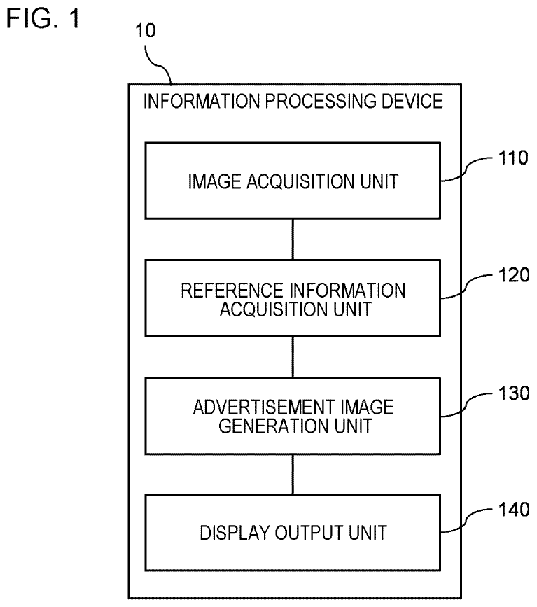

FIG. 1 is a diagram depicting an outline of an information processing device 10 according to a first example embodiment. The information processing device 10 illustrated in this figure includes an image acquisition unit 110, a reference information acquisition unit 120, an advertisement image generation unit 130, and a display output unit 140.

The image acquisition unit 110 acquires an image of a product targeted for advertising. The image of the product may include one or a plurality of still images or a moving image. The reference information acquisition unit 120 acquires information (hereinafter, also referred to as “reference information”) to be used to determine data (hereinafter, also referred to as “additional data”) to be added to the image of the product acquired by the image acquisition unit 110. The advertisement image generation unit 130 generates an advertisement image, using the image of the product acquired by the image acquisition unit 110 and the additional data determined based on the reference information acquired by the reference information acquisition unit 120. The display output unit 140 outputs the advertisement image generated by the advertisement image generation unit 130 to a display device (not illustrated) associated with a store that sells the product targeted for advertising.

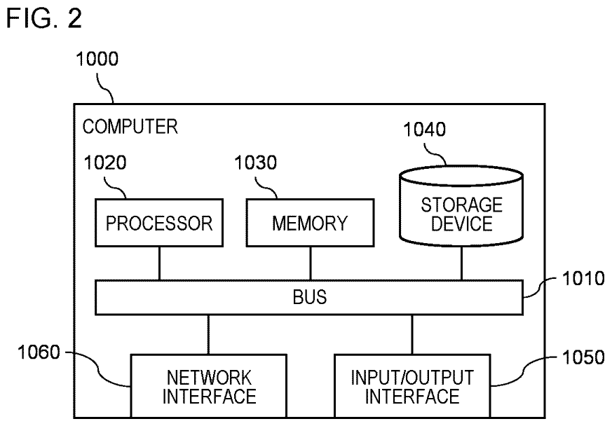

FIG. 2 is a diagram illustrating a hardware configuration of a computer 1000 that implements the information processing device 10 according to the present disclosure.

The computer 1000 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to transmit and receive data to and from each other. However, the method for connecting the processor 1020 and the like to each other is not limited to the bus connection.

The processor 1020 is a central processing unit (CPU), a graphics processing unit (GPU), or the like.

The memory 1030 is a main storage device implemented by a random access memory (RAM) or the like.

The storage device 1040 is an auxiliary storage device implemented by a hard disk drive (HDD), a solid state drive (SSD), a memory card, a read only memory (ROM), or the like. The storage device 1040 stores at least a program module that implements the functions (the image acquisition unit 110, the reference information acquisition unit, the advertisement image generation unit 130, and the display output unit 140) of the information processing device 10 described above.

The processor 1020 implements a function related to a program module by loading the program module read from the storage device 1040 into the memory 1030 and executing the loaded program module. For example, the processor 1020 implements the function of the image acquisition unit 110 described in the present disclosure by reading a program module related to the image acquisition unit 110 on the memory 1030 and executing the read program module. Similarly, the processor 1020 implements the function of the reference information acquisition unit 120 described in the present disclosure by reading a program module related to the reference information acquisition unit 120 on the memory 1030 and executing the read program module. Similarly, the processor 1020 implements the function of the advertisement image generation unit 130 described in the present disclosure by reading a program module related to the advertisement image generation unit 130 on the memory 1030 and executing the read program module. Similarly, the processor 1020 implements the function of the display output unit 140 described in the present disclosure by reading a program module related to the display output unit 140 on the memory 1030 and executing the read program module. This operation of the processor 1020 is common to the example embodiments included in the present disclosure.

The program module described above may be recorded in a recording medium other than the storage device 1040. The recording medium that records the program module includes any medium that can be used by the non-transitory tangible computer 1000. A program code that can be read by the computer 1000 (processor 1020) may be embedded in the recording medium that records the program module.

The input/output interface 1050 is an interface for connecting between the computer 1000 and various pieces of input/output equipment.

The network interface 1060 is an interface for connecting the computer 1000 to a network. The network includes a local area network (LAN), a wide area network (WAN), and the like, for example. The network interface 1060 connects the computer 1000 (information processing device 10) to various networks by wireless or wired connection. The computer 1000 (information processing device 10) can communicate with a database in a store or another computer (such as a server device or a management terminal in a head office) as will be described later, via the network interface 1060.

The computer 1000 is connected to necessary pieces of equipment via the input/output interface 1050 or the network interface 1060. The “necessary piece of equipment” mentioned here is not particularly limited, but examples thereof include an input device such as an instruction button, a keyboard, a touch panel, or a mouse, and an output device such as a display, a camera, a speaker, a microphone, or a printer, for example.

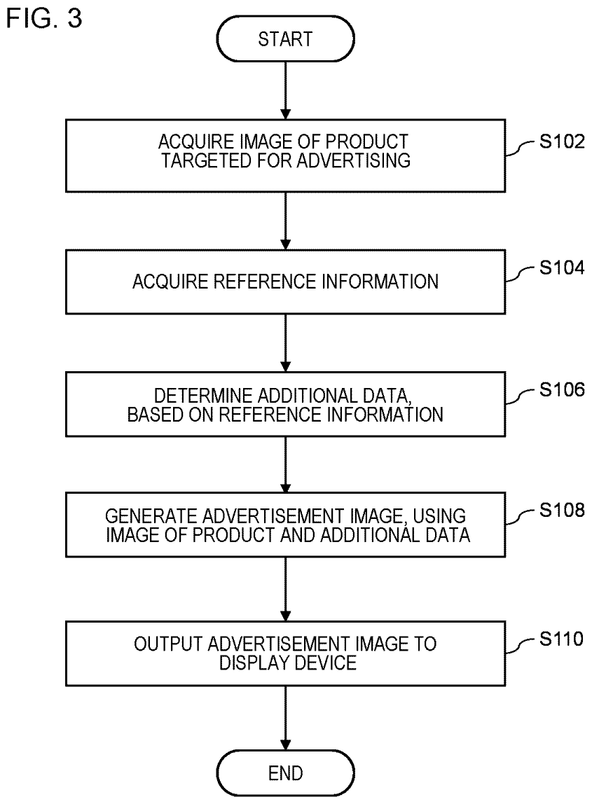

FIG. 3 is a flowchart illustrating a process executed by the information processing device 10 according to the first example embodiment. The process to be described here is executed at any timing. For example, a process to be described later is executed in accordance with a schedule predefined for an advertisement of a product.

First, the image acquisition unit 110 acquires an image of a product targeted for advertising (step S102). Following or in parallel to step S102, the reference information acquisition unit 120 acquires the reference information (step S104). The reference information is information used to determine data desired to be added to the image of the product in order to enhance the appeal effect of the product advertisement. A specific example of the reference information will be described in another example embodiment to be described later. Then, based on the reference information acquired in step S104, the advertisement image generation unit 130 acquires additional data to be added to the image of the product acquired in S102 (step S106). Thereafter, the advertisement image generation unit 130 generates an advertisement image, using the image of the product acquired in step S102 and the additional data acquired in step S106 (step S108). A specific example of this operation of the advertisement image generation unit 130 will be described in another example embodiment to be described later. Then, the display output unit 140 outputs the advertisement image generated in step S108 to a display device associated with a store that sells the product targeted for advertising (step S110).

According to the configuration of this example embodiment, an information processing device, a product advertisement method, and a non-transitory computer-readable recording medium for enhancing an appeal effect of a product advertisement are obtained.

Hereinafter, in another example embodiment, a detailed example of the information processing device 10 will be described.

### Second Example Embodiment

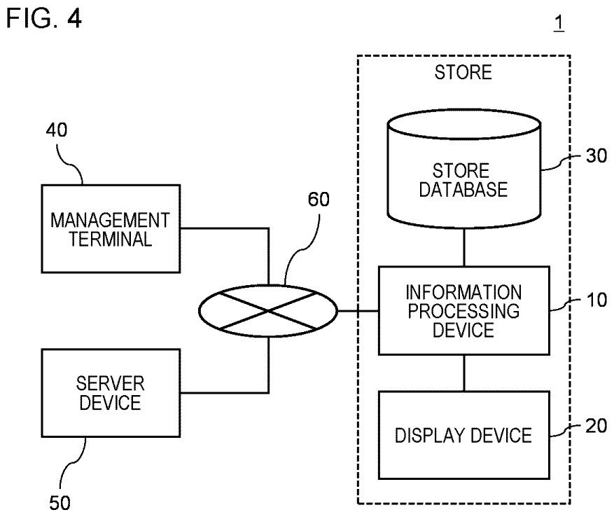

FIG. 4 is a diagram illustratively depicting a configuration of a product advertisement system 1 including the information processing device 10.

The product advertisement system 1 illustrated in FIG. 4 has a configuration including a display device 20, a store database 30, a management terminal 40, and a server device 50 together with the above-described information processing device 10. As illustrated, the information processing device 10, the display device 20, and the store database 30 are provided on the premises of a certain store. The management terminal 40 and the server device 50 are connected to the information processing device 10 via a network 60. The system configuration in this figure is merely an example, and a system configuration different from the system configuration illustrated in this figure may be adopted. For example, the store database 30 may be connected to the information processing device 10 via the network 60.

The display device 20 is supplied with an advertisement image from the information processing device 10 and displays the supplied advertisement image. The display device 20 is installed at any place on the premises of the store (inside or outside the store). The display device 20 may be a digital signage device or a general display device. The display device 20 installed outside the store is preferably configured using an outdoor high-luminance LED display in order to ensure visibility. The display device 20 installed inside the store may be configured using a normal liquid crystal display or the like in consideration of cost. The display device 20 may sometimes be provided on a wall or a glass surface that separates the inside and the outside of the store. In this case, the display device 20 may be configured in such a way as to include an outdoor high-luminance LED display on a first surface and include a normal liquid crystal display on a second surface located on an opposite side of the first surface.

The store database 30 stores various sorts of information used in the store business. For example, the store database 30 stores data of products sold in the store, content data for product advertisement (data relating to product images and additional data), data relating to a schedule of product advertisement, inventory status data of each product, delivery status data of each product, and the like. The information processing device 10 can acquire information used in each of the above-described processing units from the store database 30.

The management terminal 40 is used in a head office that manages and runs a plurality of stores including the store depicted in the present figure. The management terminal 40 manages various sorts of data used in the business of the store. For example, the management terminal 40 manages master data of product information, master data of content for product advertisement, master data relating to a basic schedule of product advertisement, and the like. The management terminal 40 transmits data required in other devices (for example, the information processing device 10 and the server device 50) to each device via the network 60.

The server device 50 has a function of receiving a basic schedule of the product advertisement from the management terminal 40 and determining a schedule of the product advertisement customized for each store, based on the received basic schedule. For example, the server device 50 can customize the basic schedule of the product advertisement, based on a product sold in each store. As a specific example, the server device 50 refers to information indicating the list of the products sold in the targeted store and modifies the basic schedule of the product advertisement in such a way as to include only the products sold in the targeted store. The server device 50 transmits the schedule of the product advertisement customized for the target store to the information processing device 10 or another computer provided in the target store. The information processing device 10 or the another computer stores data relating to the schedule of the product advertisement acquired from the server device 50 in, for example, the store database 30.

Hereinafter, a process executed by the information processing device 10 according to the second example embodiment will be described with reference to the figures.

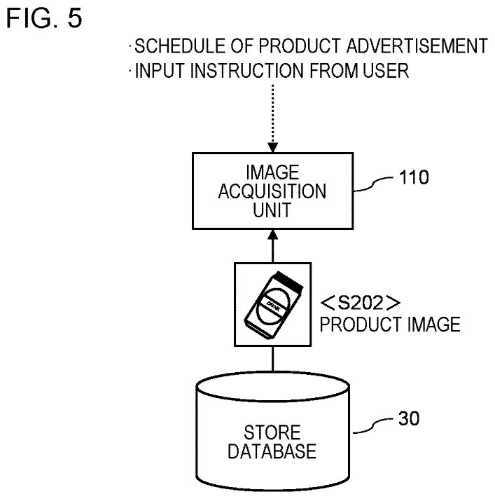

FIG. 5 is a diagram for explaining an operation of the image acquisition unit 110 according to the second example embodiment. The image acquisition unit 110 acquires an image of a product targeted for advertising from the store database 30, according to data relating to the schedule of the product advertisement or an input instruction from a user (S202). For example, the image acquisition unit 110 specifies an advertising target product with reference to data relating to the schedule of the product advertisement stored in the store database 30. In addition, the image acquisition unit 110 may accept, via an input device connected to the information processing device 10, an input instruction from the user for designating a product targeted for advertising. Then, the image acquisition unit 110 refers to the content data stored in the store database 30 and acquires image data of the product related to the specified product. The operation of the image acquisition unit 110 is not limited to the operation illustrated in FIG. 5. For example, the image of the product and the content data may be stored in a storage area of the server device 50. In this case, the image acquisition unit 110 may acquire the image of the product and the content data from the server device 50.

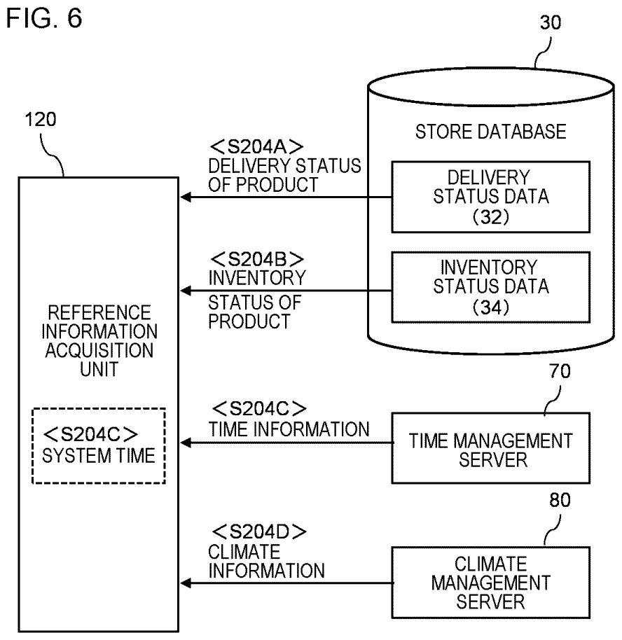

FIG. 6 is a diagram for explaining an operation of the reference information acquisition unit 120 according to the second example embodiment. Following or in parallel to step S202, the reference information acquisition unit 120 acquires the reference information. As described earlier, the reference information is information used to determine data desired to be added to the image of the product in order to enhance the appeal effect of the product advertisement. Specific examples of the reference information include delivery information indicating a delivery status of a product, inventory information indicating an inventory status of a product, time information on a region to which the target store belongs, and climate information on the region to which the target store belongs. The reference information acquisition unit 120 acquires at least one of these pieces of information (the delivery information, the inventory information, the time information, and the climate information), as the reference information.

As an example, with reference to delivery status data 32 of each product stored in the store database 30, the reference information acquisition unit 120 can acquire information indicating a delivery status of the product specified in step S202, as the reference information (step S204A). As another example, with reference to inventory status data 34 of each product stored in the store database 30, the reference information acquisition unit 120 can acquire information indicating an inventory status of the product specified in step S202, as the reference information (step S204B). As another example, the reference information acquisition unit 120 can acquire the time information on a region to which the store belongs, as the reference information (step S204C). In this case, the reference information acquisition unit 120 can acquire, for example, system time managed inside a computer that implements the information processing device 10, as the time information. For example, the reference information acquisition unit 120 may communicate with a time management server 70 and acquire the time information related to the region to which the store belongs. In this case, the time management server 70 is communicatively connected to the information processing device 10 via the network 60. As another example, the reference information acquisition unit 120 can communicate with, for example, a climate management server 80 that manages the climate information on each region and acquire the climate information on the region to which the store belongs, as the reference information (step S204D). In this case, the climate management server 80 is communicatively connected to the information processing device 10 via the network 60. Although not illustrated, in a case where the server device 50 collects and manages the climate information on each region, the information processing device 10 may communicate with the server device 50 to acquire the climate information on the region to which the store belongs.

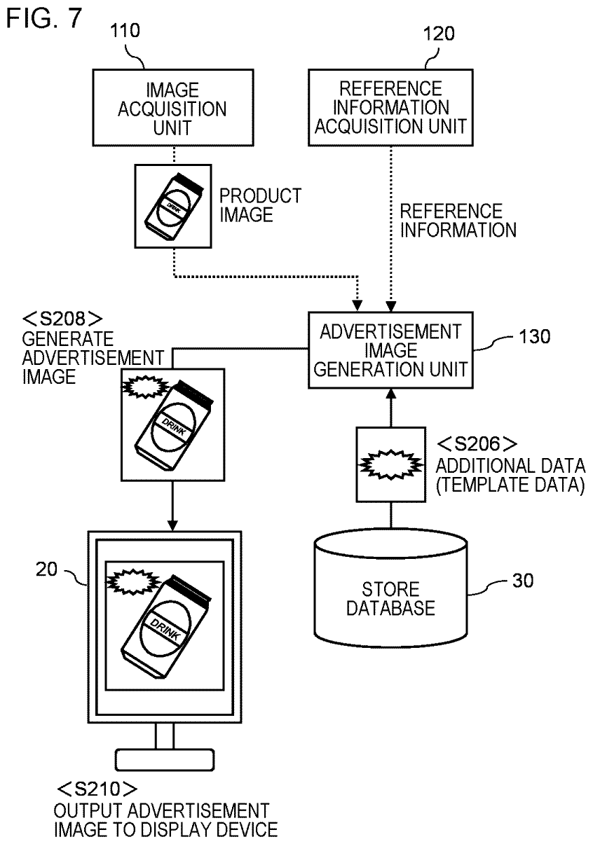

FIG. 7 is a diagram for explaining an operation of the advertisement image generation unit 130 according to the second example embodiment. First, the advertisement image generation unit 130 determines additional data to be added to the image of the product acquired in step S202, using the reference information acquired in at least one of steps S204A to S204D (S206). For example, it is assumed that a variety of sorts of additional data are included in the content data for product advertisement stored in the store database 30. In this case, the advertisement image generation unit 130 reads the additional data related to the reference information acquired in at least one of steps S204A to S204D, from the store database 30. It is also assumed that the content data for product advertisement stored in the store database 30 includes template data for generating additional data. In this case, the advertisement image generation unit 130 generates the additional data by editing the template data read from the store database 30, using the reference information acquired in at least one of steps S204A to S204D. In this manner, the advertisement image generation unit 130 determines additional data desired to be added to the image of the product acquired in step S202. The operation of the advertisement image generation unit 130 is not limited to the operation illustrated in FIG. 7. For example, the additional data or the template data for generating the additional data may be stored in a storage area of the server device 50. In this case, the advertisement image generation unit 130 may acquire the additional data or the template data for generating the additional data from the server device 50.

Then, the advertisement image generation unit 130 generates an advertisement image, using the image of the product acquired in step S202 and the additional data determined in step S206 (S208). Then, the display output unit 140 outputs the advertisement image generated in step S208 to the display device 20 (S210).

Hereinafter, the advertisement image output by the advertisement image generation unit 130 to the display device 20 will be specifically described.

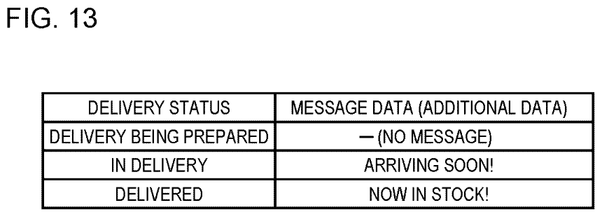

As an example, it is assumed that the reference information acquisition unit 120 has acquired the delivery information (information indicating a delivery status of the product), as the reference information. In this case, the advertisement image generation unit 130 combines message data based on the delivery status of the product indicated by the acquired delivery information with the image of the product, as the additional data. For example, the advertisement image generation unit 130 can specify message data according to the delivery status indicated by the delivery information, as the additional data, with reference to the information as illustrated in FIG. 13. FIG. 13 is a diagram depicting an example of information defining a correspondence relationship between delivery statuses indicated by the delivery information and message data to be added to the image. As a specific example, it is assumed that the delivery information acquired as the reference information indicates a status of “in delivery”. In this case, based on the information illustrated in FIG. 13, the advertisement image generation unit 130 determines message data (for example, message data such as “Arriving soon!”) indicating that the product will arrive soon, as the additional data to be combined with the image of the product. As another specific example, it is assumed that the delivery information acquired as the reference information indicates a status of “delivered”. In this case, based on the information illustrated in FIG. 13, the advertisement image generation unit 130 determines message data (for example, message data such as “Now in stock!”) indicating that the product has arrived, as the additional data to be combined with the image of the product. Such message data may be stored in the store database 30 in advance, or may be generated by the advertisement image generation unit 130 editing the template data stored in the store database 30 based on the reference information. In this manner, the advertisement image generation unit 130 can determine the additional data to be added to the image of the product. In the example in FIG. 13, there is no message data related to a status of “delivery being prepared”. Therefore, in the case of using the information illustrated in FIG. 13, in a case where the delivery information indicating the status of “delivery being prepared” is acquired, the advertisement image generation unit 130 deduces that there is no message data to be added to the image.

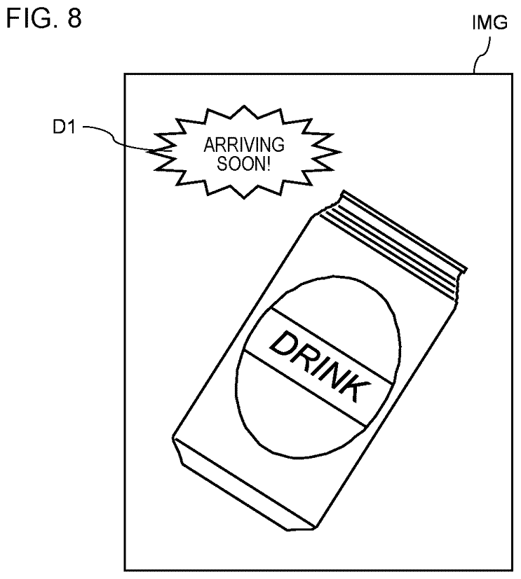

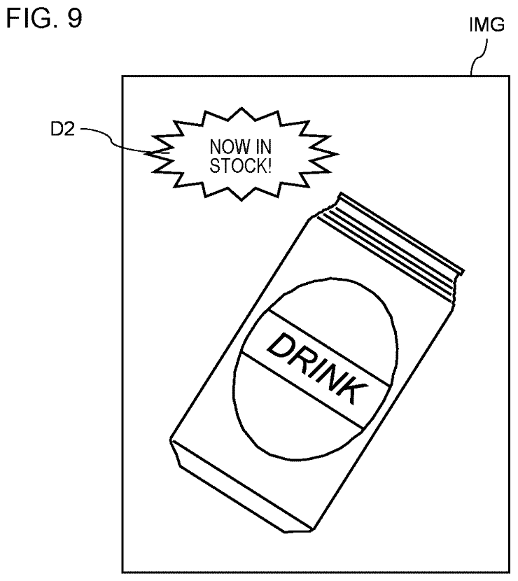

Then, the advertisement image generation unit 130 generates an advertisement image as illustrated in FIG. 8 or 9, for example, using the additional data determined as described above. FIGS. 8 and 9 are diagrams depicting examples of advertisement images generated by the advertisement image generation unit 130, based on information indicating a delivery status of a product. The advertisement image illustrated in FIG. 8 is generated by superimposing message data DI of “Arriving soon!” on an image IMG of a product (drink product) targeted for advertising. The advertisement image illustrated in FIG. 9 is generated by superimposing message data D2 of “Now in stock!” on an image IMG of a product (drink product) targeted for advertising. By viewing such an advertisement image, the customer knows that the product in the viewing advertisement image can be purchased at the store soon or the product in the advertisement image has become available for purchase just now. By presenting additional information indicating that “the product can be purchased soon” or “the product has become available for purchase just now” to the customer, an effect of further stimulating the customer's willingness to purchase can be expected.

As another example, it is assumed that the reference information acquisition unit 120 has acquired the inventory information (information indicating an inventory status of the product), as the reference information. In this case, the advertisement image generation unit 130 combines message data based on the inventory quantity of the product indicated by the acquired inventory information with the image of the product, as the additional data. For example, it is assumed that the inventory information acquired as the reference information has information of “inventory quantity: three”. In this case, the advertisement image generation unit 130 determines message data (for example, message data such as “Three remaining!”) indicating the inventory quantity of the product, as the additional data to be combined with the image of the product. Such message data may be stored in the store database 30 in advance, or may be generated by the advertisement image generation unit 130 editing the template data stored in the store database 30 based on the reference information. In this manner, the advertisement image generation unit 130 can determine the additional data to be added to the image of the product.

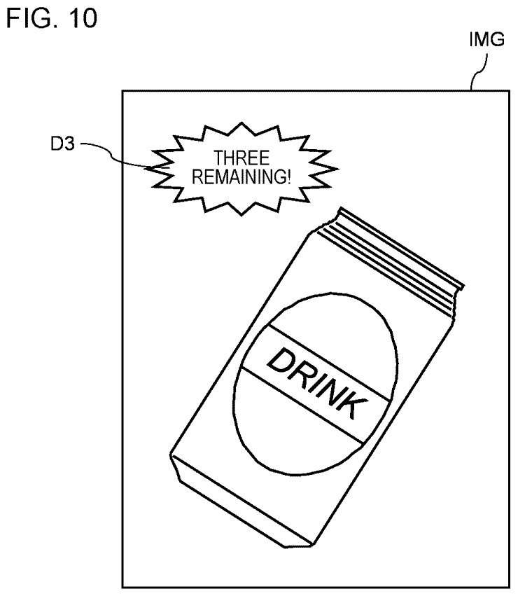

Then, the advertisement image generation unit 130 generates an advertisement image as illustrated in FIG. 10, for example, using the additional data determined as described above. FIG. 10 is a diagram depicting an example of an advertisement image generated by the advertisement image generation unit 130, based on information indicating an inventory status of a product. The advertisement image illustrated in FIG. 10 is generated by superimposing message data D3 of “Three remaining!” on an image IMG of a product (drink product) targeted for advertising. By viewing such an advertisement image, the customer can know the possibility that the product in the viewing advertisement image will be sold out soon. As a result, an effect of increasing rarity (attraction) felt by the customer for the product in the advertisement image and further stimulating customer's willingness to purchase can be expected.

As another example, it is assumed that the reference information acquisition unit 120 has acquired the time information as the reference information. In this case, the advertisement image generation unit 130 combines message data based on the time indicated by the acquired time information with the image of the product, as the additional data. For example, it is assumed that the advertising target product is a food and the time information indicates around lunch time (such as 11:00 to 13:00). In this case, the advertisement image generation unit 130 generates message data (for example, message data such as “Recommended for lunch!”) for publicizing the target product for lunch. Such message data may be stored in the store database 30 in advance, or may be generated by the advertisement image generation unit 130 editing the template data stored in the store database 30 based on the reference information. In this manner, the advertisement image generation unit 130 can determine the additional data to be added to the image of the product.

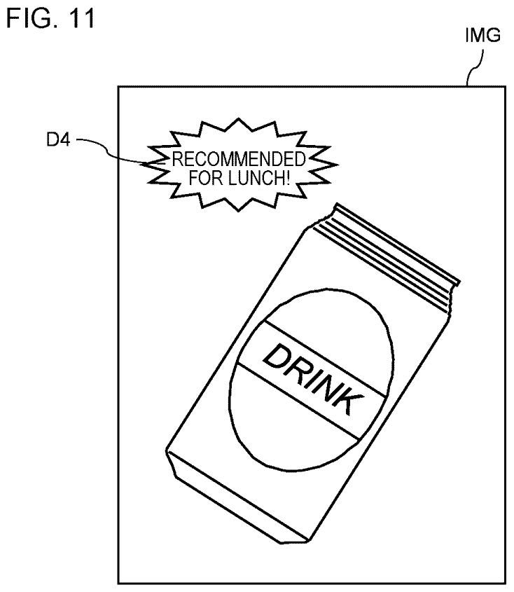

Then, the advertisement image generation unit 130 generates an advertisement image as illustrated in FIG. 11, for example, using the additional data determined as described above. FIG. 11 is a diagram depicting an example of an advertisement image generated by the advertisement image generation unit 130, based on the time information. The advertisement image illustrated in FIG. 11 is generated by superimposing message data D4 of “Recommended for lunch!” on an image IMG of a product (drink product) targeted for advertising. By outputting such an advertisement image to the display device 20, an effect of increasing attraction felt by the customer for the product in the output advertisement image and further stimulating the customer's willingness to purchase can be expected.

As another example, it is assumed that the reference information acquisition unit 120 has acquired the climate information as the reference information. In this case, the advertisement image generation unit 130 combines message data based on the climate or the weather indicated by the acquired climate information with the image of the product, as the additional data. For example, the advertisement image generation unit 130 specifies the temperature or a variation in temperature at the timing of outputting the advertisement image or the weather at the output timing, based on the climate information. Here, it is assumed that the target product for advertisement is a food, and the advertisement image generation unit 130 has detected a temperature equal to or higher than a particular temperature or a rising variation in temperature, based on the climate information. In this case, the advertisement image generation unit 130 determines message data (for example, message data such as “For nutrition supplementation in hot weather!”) for publicizing the product in response to the rise in temperature, as the additional data to be combined with the image of the product. Such message data may be stored in the store database 30 in advance, or may be generated by the advertisement image generation unit 130 editing the template data stored in the store database 30 based on the reference information. In this manner, the advertisement image generation unit 130 can determine the additional data to be added to the image of the product.

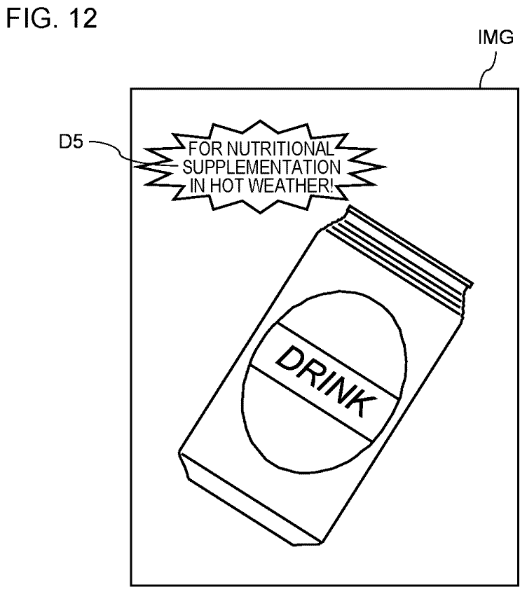

Then, the advertisement image generation unit 130 generates an advertisement image as illustrated in FIG. 12, for example, using the additional data determined as described above. FIG. 12 is a diagram depicting an example of an advertisement image generated by the advertisement image generation unit 130, based on the climate information. The advertisement image illustrated in FIG. 12 is generated by superimposing message data D5 of “Nutrition supplementation when hot!” on an image IMG of a product (drink product) targeted for advertising. By outputting such an advertisement image to the display device 20, an effect of increasing attraction felt by the customer for the product in the output advertisement image and further stimulating the customer's willingness to purchase can be expected.

As described above, according to the present example embodiment, the advertisement image is generated using the image of the product and the additional data determined based on the reference information serving as a reference for deducing the additional data desired to be added to the product image. Then, the generated advertisement image is output to the display device associated with the store. By including the additional data in the advertisement image, an advertisement image that further stimulates customer's willingness to purchase can be presented to the customer. That is, the appeal effect of the advertisement image can be enhanced.

### Modification of Second Example Embodiment

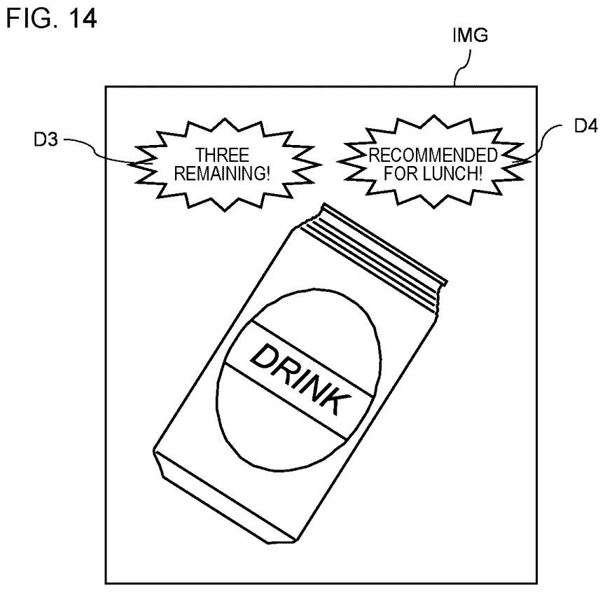

As a modification of the present example embodiment, the advertisement image generation unit 130 may determine a plurality of pieces of additional data, based on a plurality of types of reference information. For example, it is assumed that the reference information acquisition unit 120 has acquired the time information and the inventory information on a target product, as the reference information. In this case, the advertisement image generation unit 130 may generate an advertisement image by combining the additional data including first message data based on the inventory information and second message data based on the time information with the image of the target product. In this case, the advertisement image generation unit 130 generates an advertisement image including the message data D3 illustrated in FIG. 10 and the message data D4 illustrated in FIG. 11. Then, the advertisement image generation unit 130 outputs the advertisement image (example: FIG. 14) including two types of message data to the display device 20. FIG. 14 is a diagram depicting an example of an advertisement image generated by the advertisement image generation unit 130 according to the modification of the second example embodiment. The advertisement image illustrated in FIG. 14 is generated by superimposing the message data D3 of “Three remaining!” and the message data D4 of “Recommended for lunch!” on an image IMG of a product (drink product) targeted for advertising. Note that the advertisement image including a plurality of types of message data is not limited to the example in FIG. 14. For example, in a case where an advertisement image including two types of message data is generated, the advertisement image generation unit 130 may generate one piece of message data by combining the message data D3 and the message data D4. Alternatively, for example, the advertisement image generation unit 130 may generate an advertisement image in which the message data D3 and the message data D4 are switched and displayed at a predetermined timing. By outputting such an advertisement image to the display device 20, an effect of increasing attraction felt by the customer for the product in the output advertisement image and further stimulating the customer's willingness to purchase can be expected.

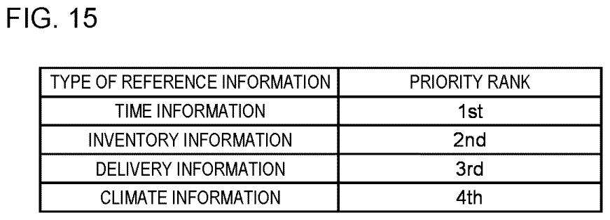

In a case where the reference information acquisition unit 120 acquires two or more types of reference information, the advertisement image generation unit 130 may determine additional data to be added to the image of the product, based on priority ranks predefined for each type of reference information. For example, a case will be treated in which the reference information acquisition unit 120 has acquired, as the reference information, two or more pieces of information among the delivery information indicating a delivery status of a product, the inventory information indicating an inventory status of a product, the time information on a region to which a target store belongs, and the climate information on the region to which the target store belongs. In this case, information indicating priority ranks is associated with each of the delivery information, the inventory information, the time information, and the climate information in advance. The information indicating a correspondence relationship between the types of reference information and the priority ranks is stored in advance in a storage area (such as the storage device 1040, for example) accessible by the advertisement image generation unit 130. For example, information as illustrated in FIG. 15 is stored in the storage device 1040 or the like. FIG. 15 is a diagram depicting an example of information defining a correspondence relationship between types of reference information and priority ranks.

Here, it is assumed that the reference information acquisition unit 120 has acquired four types of reference information of the delivery information, the inventory information, the time information, and the climate information. In this case, the advertisement image generation unit 130 specifies the priority rank of each kind of information, based on the information as illustrated in FIG. 15. Then, the advertisement image generation unit 130 adds, for example, a limited number of pieces of the additional data to the image of the product, based on the specified priority ranks. For example, it is assumed that information assuming that the upper limit number of pieces of the additional data is “2” is stored in advance in a storage area such as the storage device 1040. In this case, the advertisement image generation unit 130 can determine the additional data desired to be added to the image of the product, based on the information on the upper limit number of pieces of the additional data and the priority ranks for each type of the reference information. As a specific example, a case where the upper limit number of pieces of the additional data is “2” and the information in FIG. 15 is used will be treated. In this case, the advertisement image generation unit 130 determines the additional data based on the “time information” (example: the message data D4 in FIG. 11) and the additional data based on the “inventory information” (example: the message data D3 in FIG. 10), as the additional data desired to be added to the image of the product. The advertisement image generation unit 130 deduces that the additional data relating to the “delivery information” and the “climate information” acquired along with the above is data not to be added to the image of the product, based on the priority ranks. According to such a “configuration in which the additional data desired to be added to the product image is narrowed down based on the priority ranks”, a reduction in the appeal effect of the advertisement image, which could otherwise be caused by the inclusion of too much information, can be avoided.

According to the present modification, a plurality of types of the additional information can be included in an advertisement image. This can further enhance the appeal effect by the advertisement image.

While the example embodiments of the present invention have been described above with reference to the drawings, these are examples of the present invention, and various configurations other than the above can also be adopted.

In the flowcharts or sequence diagrams used in the above description, a plurality of steps (processes) are described in order, but the execution order of the steps executed in each example embodiment is not limited to the described order. In each example embodiment, the order of the illustrated steps can be changed as long as nothing interferes in terms of content. The above-described example embodiments can be combined unless otherwise contradicted in content.

Some or all of the above example embodiments may also be described as the following Supplementary Notes, but are not limited to the following.
1.

An information processing device including:
an image acquisition means for acquiring an image of a product targeted for advertising;
a reference information acquisition means for acquiring reference information to be used to determine additional data for the image;
an advertisement image generation means for generating an advertisement image, using the image and the additional data determined based on the reference information, and
a display output means for outputting the advertisement image to a display device associated with a store that sells the product.
2.

The information processing device according to 1, in which
the reference information acquisition means acquires at least one of delivery information on the product, inventory information on the product, time information on a region to which the store belongs, and climate information on the region to which the store belongs, as the reference information.
3.

The information processing device according to 2, in which
the advertisement image generation means generates the advertisement image by combining message data based on a delivery status of the product indicated by the delivery information with the image, as the additional data, in a case where the delivery information is acquired as the reference information.
4.

The information processing device according to 2, in which
the advertisement image generation means generates the advertisement image by combining message data based on an inventory quantity of the product indicated by the inventory information with the image, as the additional data, in a case where the inventory information is acquired as the reference information.
5.

The information processing device according to 2, in which
the advertisement image generation means generates the advertisement image by combining message data based on a time indicated by the time information with the image, as the additional data, in a case where the time information is acquired as the reference information.
6.

The information processing device according to 2, in which
the advertisement image generation means generates the advertisement image by combining message data based on temperature or weather indicated by the climate information with the image, as the additional data, in a case where the climate information is acquired as the reference information.
7.

The information processing device according to 2, in which
the reference information acquisition means acquires two or more pieces of information among the delivery information on the product, the inventory information on the product, the time information on the region to which the store belongs, and the climate information on the region to which the store belongs, as the reference information, and
the advertisement image generation means generates the advertisement image by combining message data related to each of the two or more pieces of information with the image, as the additional data.
8.

The information processing device according to 7, in which
priority ranks are assigned for each of the delivery information on the product, the inventory information on the product, the time information on the region to which the store belongs, and the climate information on the region to which the store belongs, and
the advertisement image generation means determines the additional data to be added to the image, based on the priority ranks for each of the two or more pieces of information.
9.

A product advertisement method
performed by at least one computer, the product advertisement method including:
acquiring an image of a product targeted for advertising;
acquiring reference information to be used to determine additional data for the image;
generating an advertisement image, using the image and the additional data determined based on the reference information; and
outputting the advertisement image to a display device associated with a store that sells the product.
10.

The product advertisement method according to 9, including
acquiring, by the at least one computer, at least one of delivery information on the product, inventory information on the product, time information on a region to which the store belongs, and climate information on the region to which the store belongs, as the reference information.
11.

The product advertisement method according to 10, including
generating, by the at least one computer, the advertisement image by combining message data based on a delivery status of the product indicated by the delivery information with the image, as the additional data, in a case where the delivery information is acquired as the reference information.
12.

The product advertisement method according to 10, including
generating, by the at least one computer, the advertisement image by combining message data based on an inventory quantity of the product indicated by the inventory information with the image, as the additional data, in a case where the inventory information is acquired as the reference information.
13.

The product advertisement method according to 10, including
generating, by the at least one computer, the advertisement image by combining message data based on a time indicated by the time information with the image, as the additional data, in a case where the time information is acquired as the reference information.
14.

The product advertisement method according to 10, including
generating, by the at least one computer, the advertisement image by combining message data based on temperature or weather indicated by the climate information with the image, as the additional data, in a case where the climate information is acquired as the reference information.
15.

The product advertisement method according to 10, including:
acquiring, by the at least one computer, two or more pieces of information among the delivery information on the product, the inventory information on the product, the time information on the region to which the store belongs, and the climate information on the region to which the store belongs, as the reference information; and
generating, by the at least one computer, the advertisement image by combining message data related to each of the two or more pieces of information with the image, as the additional data.
16.

The product advertisement method according to 15, in which
priority ranks are assigned for each of the delivery information on the product, the inventory information on the product, the time information on the region to which the store belongs, and the climate information on the region to which the store belongs, the product advertisement method including
determining, by the at least one computer, the additional data to be added to the image, based on the priority ranks for each of the two or more pieces of information.
17.

A non-transitory computer-readable recording medium recording a program
for causing, by being executed by at least one computer, the at least one computer to function as:
an image acquisition means for acquiring an image of a product targeted for advertising;
a reference information acquisition means for acquiring reference information to be used to determine additional data for the image;
an advertisement image generation means for generating an advertisement image, using the image and the additional data determined based on the reference information; and
a display output means for outputting the advertisement image to a display device associated with a store that sells the product.
18.

The non-transitory computer-readable recording medium according to 17, in which
the reference information acquisition means acquires at least one of delivery information on the product, inventory information on the product, time information on a region to which the store belongs, and climate information on the region to which the store belongs, as the reference information.
19.

The non-transitory computer-readable recording medium according to 18, in which
the advertisement image generation means generates the advertisement image by combining message data based on a delivery status of the product indicated by the delivery information with the image, as the additional data, in a case where the delivery information is acquired as the reference information.
20.

The non-transitory computer-readable recording medium according to 18, in which
the advertisement image generation means generates the advertisement image by combining message data based on an inventory quantity of the product indicated by the inventory information with the image, as the additional data, in a case where the inventory information is acquired as the reference information.
21.

The non-transitory computer-readable recording medium according to 18, in which
the advertisement image generation means generates the advertisement image by combining message data based on a time indicated by the time information with the image, as the additional data, in a case where the time information is acquired as the reference information.
22.

The non-transitory computer-readable recording medium according to 18, in which
the advertisement image generation means generates the advertisement image by combining message data based on temperature or weather indicated by the climate information with the image, as the additional data, in a case where the climate information is acquired as the reference information.
23.

The non-transitory computer-readable recording medium according to 18, in which
the reference information acquisition means acquires two or more pieces of information among the delivery information on the product, the inventory information on the product, the time information on the region to which the store belongs, and the climate information on the region to which the store belongs, as the reference information, and
the advertisement image generation means generates the advertisement image by combining message data related to each of the two or more pieces of information with the image, as the additional data.
24.

The non-transitory computer-readable recording medium according to 23, in which
priority ranks are assigned for each of the delivery information on the product, the inventory information on the product, the time information on the region to which the store belongs, and the climate information on the region to which the store belongs, and
the advertisement image generation means determines the additional data to be added to the image, based on the priority ranks for each of the two or more pieces of information.

### REFERENCE SIGNS LIST

1 product advertisement system
10 information processing device
1000 computer
1010 bus
1020 processor
1030 memory
1040 storage device
1050 input/output interface
1060 network interface
110 image acquisition unit
120 reference information acquisition unit
130 advertisement image generation unit
140 display output unit
20 display device
30 store database
32 delivery status data
34 inventory status data
40 management terminal
50 server device
60 network
70 time management server
80 climate management server

What is claimed is:

1. An information processing apparatus comprising:
at least one memory storing instructions; and
at least one processor configured to execute the instructions to perform operations comprising:
acquiring an image of a product targeted for advertising;
acquiring reference information to be used to determine additional data for the image;
generating an advertisement image, using the image and the additional data determined based on the reference information, and
outputting the advertisement image to a display associated with a store that sells the product.

2. The information processing apparatus according to claim 1, wherein
the operations further comprise acquiring at least one of delivery information on the product, inventory information on the product, time information on a region to which the store belongs, and climate information on the region to which the store belongs, as the reference information.

3. The information processing apparatus according to claim 2, wherein
the operations further comprise generating the advertisement image by combining message data based on a delivery status of the product indicated by the delivery information with the image, as the additional data, in a case where the delivery information is acquired as the reference information.

4. The information processing apparatus according to claim 2, wherein
the operations further comprise generating the advertisement image by combining message data based on an inventory quantity of the product indicated by the inventory information with the image, as the additional data, in a case where the inventory information is acquired as the reference information.

5. The information processing apparatus according to claim 2, wherein
the operations further comprise generating the advertisement image by combining message data based on a time indicated by the time information with the image, as the additional data, in a case where the time information is acquired as the reference information.

6. The information processing apparatus according to claim 2, wherein
the operations further comprise generating the advertisement image by combining message data based on temperature or weather indicated by the climate information with the image, as the additional data, in a case where the climate information is acquired as the reference information.

7. The information processing apparatus according to claim 2, wherein the operations further comprise
acquiring two or more pieces of information among the delivery information on the product, the inventory information on the product, the time information on the region to which the store belongs, and the climate information on the region to which the store belongs, as the reference information, and
generating the advertisement image by combining message data related to each of the two or more pieces of information with the image, as the additional data.

8. The information processing apparatus according to claim 7, wherein
priority ranks are assigned for each of the delivery information on the product, the inventory information on the product, the time information on the region to which the store belongs, and the climate information on the region to which the store belongs, and
the operations further comprise determining the additional data to be added to the image, based on the priority ranks for each of the two or more pieces of information.

9. A product advertisement method
performed by at least one computer, the product advertisement method comprising:
acquiring an image of a product targeted for advertising;
acquiring reference information to be used to determine additional data for the image;
generating an advertisement image, using the image and the additional data determined based on the reference information; and
outputting the advertisement image to a display device associated with a store that sells the product.

10. A non-transitory computer-readable medium recording a program
for causing, by being executed by at least one computer, the at least one computer to perform operations comprising:
acquiring an image of a product targeted for advertising;
acquiring reference information to be used to determine additional data for the image;
generating an advertisement image, using the image and the additional data determined based on the reference information; and
outputting the advertisement image to a display device associated with a store that sells the product.

11. The product advertisement method according to claim 9, further comprising
acquiring at least one of delivery information on the product, inventory information on the product, time information on a region to which the store belongs, and climate information on the region to which the store belongs, as the reference information.

12. The product advertisement method according to claim 11, further comprising
generating the advertisement image by combining message data based on a delivery status of the product indicated by the delivery information with the image, as the additional data, in a case where the delivery information is acquired as the reference information.

13. The product advertisement method according to claim 11, further comprising
generating the advertisement image by combining message data based on an inventory quantity of the product indicated by the inventory information with the image, as the additional data, in a case where the inventory information is acquired as the reference information.

14. The product advertisement method according to claim 11, further comprising
generating the advertisement image by combining message data based on a time indicated by the time information with the image, as the additional data, in a case where the time information is acquired as the reference information.

15. The product advertisement method according to claim 11, further comprising
generating the advertisement image by combining message data based on temperature or weather indicated by the climate information with the image, as the additional data, in a case where the climate information is acquired as the reference information.

16. The product advertisement method according to claim 11, further comprising
acquiring two or more pieces of information among the delivery information on the product, the inventory information on the product, the time information on the region to which the store belongs, and the climate information on the region to which the store belongs, as the reference information, and
generating the advertisement image by combining message data related to each of the two or more pieces of information with the image, as the additional data.

17. The product advertisement method according to claim 16, wherein
priority ranks are assigned for each of the delivery information on the product, the inventory information on the product, the time information on the region to which the store belongs, and the climate information on the region to which the store belongs, and
the product advertisement method further comprises determining the additional data to be added to the image, based on the priority ranks for each of the two or more pieces of information.
